(19) United States
(12) Patent Application Publication
(10) Pub. No.: US 2012/0206599 A1
(43) Pub. Date: Aug. 16, 2012

(54) REMOTE PHOTOGRAPHIC MONITORING SYSTEM

(76) Inventor: Rodrigo Trujillo Uribe, Cali (CO)

(21) Appl. No.: 13/209,900

(22) Filed: Aug. 15, 2011

Related U.S. Application Data
(60) Provisional application No. 61/373,820, filed on Aug. 14, 2010.

(51) Int. Cl. H04N 7/18

(52) U.S. Cl. 348/148; 348/E07.085

(57) ABSTRACT

A system that monitors the surrounding of a vehicle by taking pictures at a predetermined interval is provided. The system monitors the entire surroundings of the vehicle or specific areas around the vehicle. The system takes pictures and stores them in a hard disk drive for retrieval.

### CROSS REFERENCE TO RELATED APPLICATIONS

The present application claims priority under 35 U.S.C.§119 to the U.S. Provisional Application Ser. No. 61/373,820 entitled “SupraScopio” filed on Aug. 14, 2010, which is incorporated herein by reference in its entirety.

### BACKGROUND

1. Field of the Invention

This invention relates to a surveillance system and, in particular, a surveillance network that utilizes high resolution digital photography for recording incidents and assisting in obtaining records of events upon request by a user of the system.

2. Description of the Background

Video surveillance methods are commonly used to deter crime and to assess situations before, during, and after a particular event. Video cameras are utilized in police cars and other automobiles in order to protect police officers and civilians. Video images collected from these types of surveillance systems are not always clear and are difficult to utilize in real time. Although still photographs taken from vehicles are known in the prior art (U.S. Pat. No. 2,148,119), there is no system known to capture high resolution digital images of the environment around a vehicle continuously.

### SUMMARY OF THE INVENTION

One of the objects of the present invention is to provide a system that monitors the surrounding of a vehicle at a predetermined interval. The system monitors the entire surroundings of the vehicle or specific areas around the vehicle. The system takes pictures and stores them in a hard disk drive for retrieval.

### BRIEF DESCRIPTION OF THE DRAWINGS

FIG. 1 is a diagram of the remote photographic monitoring system.

FIG. 2 is a schematic diagram of various components of the photographic monitoring system.

FIG. 3 is a schematic diagram of another embodiment of the system.

FIG. 4 is flowchart of the method used by the system to take and store pictures.

### DETAILED DESCRIPTION

The invention summarized above may be better understood by referring to the following description. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

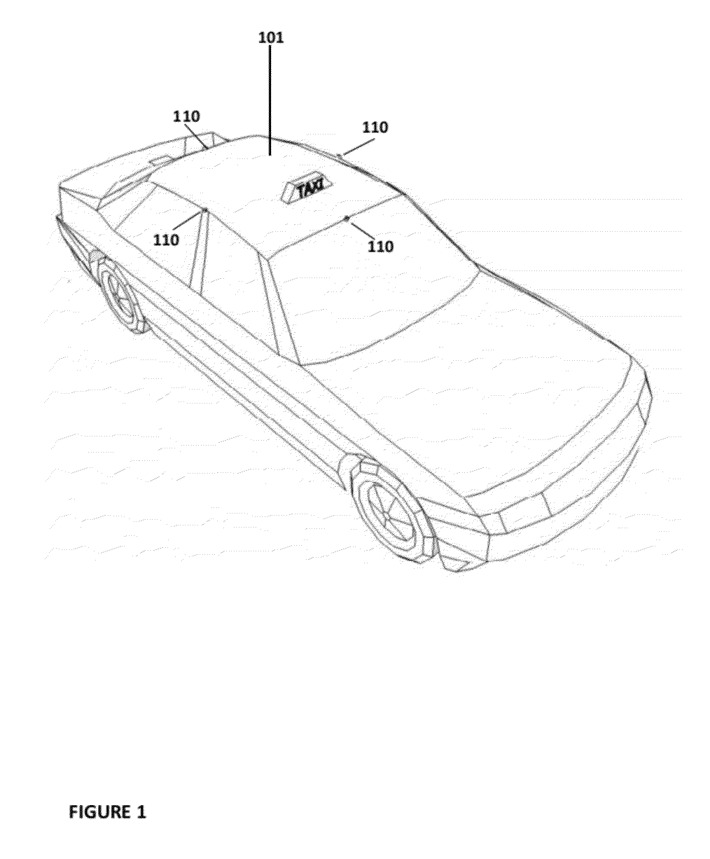

A photographic monitoring remote system is disclosed as shown in FIG. 1. In one embodiment of the present invention, the system is installed on a vehicle 101. At least two cameras 110 are placed on the vehicle 101. The cameras 110 are configured to capture high resolution digital pictures. The cameras 110 are further configure to take pictures of the entire area around the vehicle. In another embodiment, four cameras 110 as shown on FIG. 1 are utilized to cover each side of the vehicle. The cameras 110 are placed, preferably, on the roof 103 of the vehicle 101. A person of ordinary skill in the art would recognize that the cameras 110 may be placed in any position on the vehicle 101 that allows a three-hundred and sixty degree coverage of the area around the vehicle 101. The cameras 110 utilized in one embodiment are very small so that they do not interfere with the vehicle 101 design. In one preferred embodiment of the present invention the cameras have lenses of less than 5 mm in diameter. In some embodiments, the cameras 110 are concealed. In one particular embodiment, the cameras and their corresponding lenses are no bigger than a regular windshield wiper sprayer therefore not conspicuous.

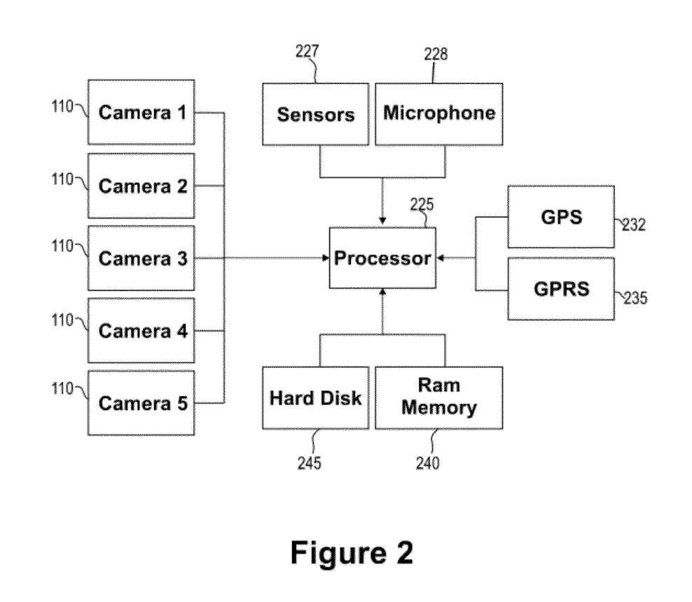

FIG. 2, shows the basic components of the system 100. The system 100 is preferably mounted on a vehicle 101. The digital cameras 110 are connected to a digital video converter 220, which converts analog images to digital images. In one preferred embodiment that cameras 110 provide digital images directly to a processor 225. A sensor 227 provides other inputs to the processor 225, such as audio, pollution, vibrations, speed, acceleration, deceleration, vehicle sensor systems, and other sensors capable of providing information to the system. A microphone 228 provides sound inputs to the processor. A global positioning system (GPS) 232 device provides location information to the processor 225. A wireless connection 235 device such as a general packet radio service (GPRS) device connects the processor 225 via a wireless connection with the internet or other systems. The processor 225 is connected to a RAM device 240 that allows quick access to information. Finally, the processor 225 is connected to a hard disk drive (HDD) 245 with capacity to store large amounts of information, including pictures and picture related data. It is contemplated that the system 220 may not include all the components listed above.

In some embodiments of the present invention, portions of the system 100 such as the processor 225, HDD 245, RAM 240, Video converter 220. GPS device 232, and wireless connection device 235 may be placed in a protective case capable of withstanding impacts, crashes, fires, bullet impacts, and other damaging activities.

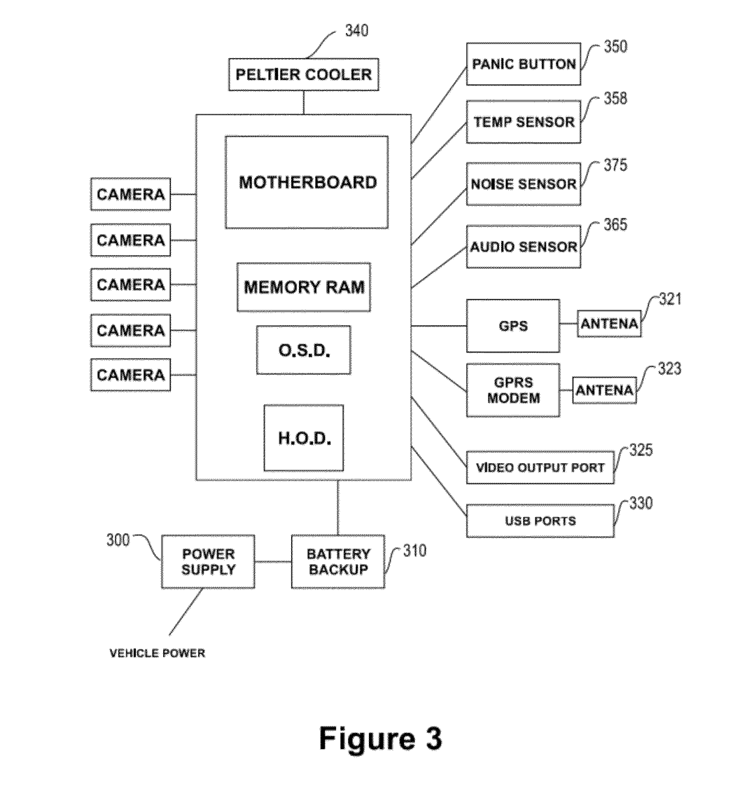

An alternative embodiment is shown in FIG. 3. In addition to the components described above, the system 100 includes a power supply 300 that is in turn powered by the vehicle's electrical system. The power supply connects to a battery backup 310 that provides auxiliary power in the event that the vehicle's electrical system 100 fails. The power supply 300 and battery backup 310 power the system 100. In an alternative embodiment of the system 100, the GPS device 232 and wireless connection device 235 each have an antenna 321 and 323 respectively for communication with the GPS servers and the internet. A further alternative embodiment includes a video output port 325 that allows physical retrieval of pictures taken by the system 100. In addition, access to the system 100 is provided through one or more USB ports 330 or other type of input/output device that allows physical or wireless communication with the system 100. In a further alternative embodiment, the system is connected to a cooling device 340, such as a peltier cooler to protect the processor 225 and other components of the system 100.

The system further comprises a signaling device 350 to be used by the driver or user of the system to automatically send pictures to a specific recipient through wireless connection device 235. In further embodiments of the system 100, a temperature sensor 358, an audio sensor 365, and a nose sensor 375 may be connected to the processor 225. A hard disk drive is inside a bullet proof box among the GPS, the GSM cellular modem, the microprocessor, the USB interface port, the software which controls the system and other elements that let it perform it purpose and/or improve its functionality.

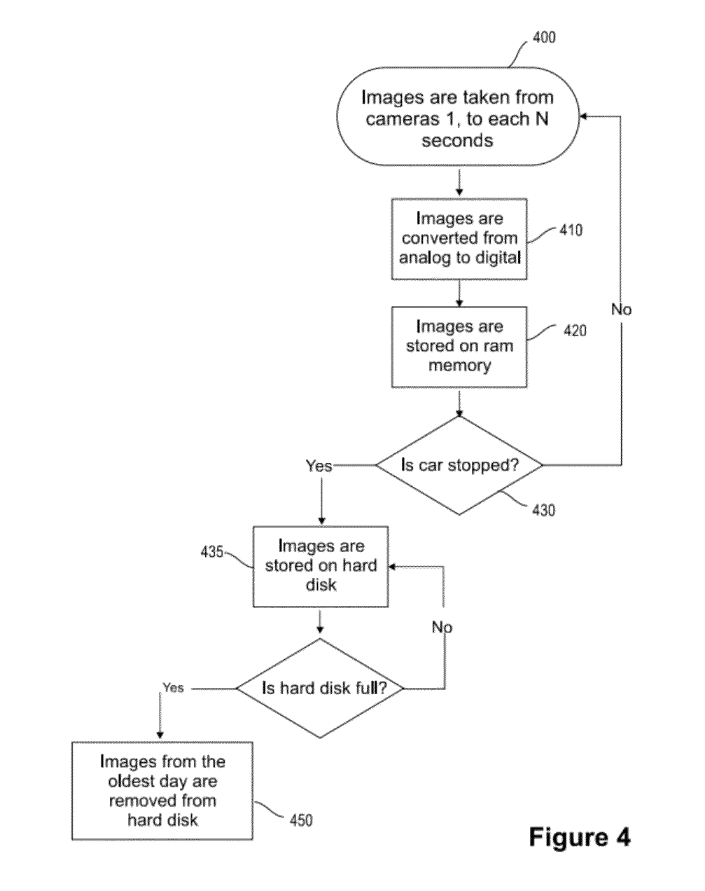

As shown in FIG. 4, the system 100 performs a method for taking and storing photographs. In the first step of the method 400, the cameras are programmed by the user to take photographs at a specific interval, by way of non-limiting example, the cameras may be programmed to take ten (10) photographs per second; the user may also program the cameras to take 1 photograph per minute or at any preferred interval. In a second step 410 the pictures are converted from analog to digital formation, if necessary. Alternatively, the cameras take digital images that do not need to be converted from analog. At the next step 420, the images are stored in RAM 240. At the next step 430, if the car is stopped, the images are saved to the HDD 245 along with the information from the GPS device 232, including location, date and time of the picture step 435. If the car is moving, the system 100 continues to take pictures and place them in RAM 240. Once the HDD 245 is full, the system 100 overwrites the oldest picture with a new picture at step 450.

The method described above, is managed by a software program on the processor. The system 100 is further programmed to allow access to the HDD 245 in order to obtain images based on a specific location, date, or time. Access is provided through the USB port 330 or the wireless connection device 235. The system 100 allows a user to send a information by pressing the panic button 350. The system 100 is programmed to send the picture to a specific location using the wireless connection device 235 when the panic button is pushed. For example, the picture may be sent to the police, it may also be sent to a central location in communication with the wireless connection device 235.

In one alternative embodiment, the system is programmed to performs different face recognitions algorithms on the photographs, comparing them to a database previously downloaded from the authorities in order to conduct search warrants, find missing persons or detect house arrests violations. If the controlling software finds a match using the face recognitions algorithm on a photograph, it sends a message to the appropriate authorities utilizing the wireless connection device 235.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A system for capturing information from a vehicle, comprising:
at least two cameras on a vehicle, which together monitor the entire area around the vehicle,
a processor connected to the at least two cameras,
a storage device, attached to the processor, wherein the two cameras take pictures at predetermined intervals.

2. The system of claim 1, further comprising a global positioning system connected to the processor.

3. The system of claim 1, further comprising a wireless connection device.

4. The system of claim 1, wherein the cameras are place on the vehicle's roof.

5. The system of claim 1, wherein the at least two cameras correspond to four cameras on each cardinal point of a the vehicle's roof.
